(19) United States
(12) Patent Application Publication
(10) Pub. No.: US 2024/0385911 A1
(43) Pub. Date: Nov. 21, 2024

(54) Inter Processor Communication using an Event Bus in Multicore Systems-on-Chip

(71) Applicant: Infineon Technologies AG, Neubiberg (DE)

(72) Inventors: Yuanfen ZHENG, Kirchheim Bei München (DE); Matthias SCHNEIDER, Kirchheim (DE)

(21) Appl. No.: 18/650,773

(22) Filed: Apr. 30, 2024

(30) Foreign Application Priority Data
May 19, 2023 (DE) 102023113196.6

(51) Int. Cl. G06F 9/54; G06F 13/40

(52) U.S. Cl. CPC G06F 9/542; G06F 13/4068

(57) ABSTRACT

One embodiment relates to a multi-code system. The system includes a first subsystem and (at least) a second subsystem, each including an event bus terminal and a processor core. The system further includes an event bus comprising an event bus controller and a plurality of bus lines for connecting the first subsystem and the second subsystem with the event bus controller. The event bus controller includes an arbiter configured to arbitrate data transmission across the bus lines. The event bus terminal of each subsystem includes a first queue for outgoing data provided by the respective processor core and a frame encoder that is configured to read the outgoing data from the first queue and transmit it to the event bus controller. The event bus terminal of each subsystem further includes a frame decoder that is configured to receive incoming data from the event bus controller and to write at least a portion of the incoming data into a selected one of data sinks wherein the selection is made based on the received data.

### RELATED APPLICATIONS

This application claims priority to earlier filed German Patent Application Serial Number DE 10 2023 113 196.6 entitled “Inter Processor Communication using an Event Bus in Multicore Systems-on-Chip,” (Attorney Docket No. IFT2422DE), filed on May 19, 2023, the entire teachings of which are incorporated herein by this reference.

### TECHNICAL FIELD

The present disclosure relates to aspects of Inter-Processor Communication in Systems-on-Chips (SoC) using an Event Bus.

### BACKGROUND

Today, systems with multiple processors or processor cores, co-processors and peripheral circuitry (e.g. random-access memory (RAM), non-volatile memory (NVM), interrupt controllers, analog-to-digital converters, digital-to-analog converters, Input/Output (I/O) interfaces, digital communication interfaces, etc.) are used in a wide variety of applications. If the mentioned processors and circuits are integrated in one chip package, they are usually referred to as System-on-Chip (SoC).

Different concepts for inter-processor communication (and communication between processor and a peripheral components) are known. An SoC may include multiple processors or processor cores and different peripheral circuits, wherein the communication between these functional units is accomplished by different bus systems (e.g. a CPU bus, an I/O bus, etc.). In systems, in which an ARM architecture is used, the CPU bus may be a so-called Advanced High-performance Bus (AHB) and the I/O bus may be an Advanced Peripheral Bus (APB). Both, AHB and APB are part of the ARM Advanced Microcontroller Bus Architecture (AMBA), which is an open standard for on-chip interconnects between different functional units of SoC designs.

When using AHB and APB for communication between different functions units (e.g. between two different processors or between a processor and a peripheral circuit), one of the processors has to control the signal flow across the bus lines. As a consequence, the software executed by this processor needs to include software routines for controlling the mentioned signal flow, which entails additional complexity of the software and difficulties in fulfilling strict real-time requirements. Furthermore, only one functional unit has access to the AHB/APB structure, while any other functional unit is stalled, if tries to access the bus at the same time.

There are concepts for communication between a processor and other functional units, in which the mentioned signal flow is controlled by hardware. Accordingly, the mentioned software routines for controlling the signal flow across the bus are not needed and complexity of the software is reduced. A less complex software may result in a reduced susceptibility to errors and better real-time capability. One example, in which such a concept has been employed in a controller for switched-mode power supplies (SMPS) is described in the publication US20190312583 A1 (hereby incorporated by reference in its entirety). This concept uses a dedicated bus (referred to as “event bus”) that that handles the communication between different functional units without involving the processor in the control of the bus communication process. In other words, the event bus allows a direct communication between two functional units (e.g. a peripheral circuit such as an ADC and a processor) without requiring the processor to manage the communication. Further, two peripheral circuits may communicate autonomously without supervision or interaction of the processor, because the event bus allows arbitrary point-to-point and point-to-multiple-points connections without involvement of the processor. It is noted that the event bus does replace the CPU bus. It may, however, partially replace the I/O bus.

As mentioned, the event bus has been developed for a very specific application (namely an SMPS controller).

### BRIEF DESCRIPTION

The above-mentioned goal is achieved by the system of claim 1 and the method of claim 6. Various embodiments and further developments are covered by the dependent claims.

One embodiment relates to a multi-code system. The system includes a first subsystem and (at least) a second subsystem, each including an event bus terminal and a processor core. The system further includes an event bus comprising an event bus controller and a plurality of bus lines for connecting the first subsystem and the second subsystem with the event bus controller. The event bus controller includes an arbiter configured to arbitrate data transmission across the bus lines. The event bus terminal of each subsystem includes a first queue for outgoing data provided by the respective processor core and a frame encoder that is configured to read the outgoing data from the first queue and transmit it to the event bus controller. The event bus terminal of each subsystem further includes a frame decoder that is configured to receive incoming data from the event bus controller and to write at least a portion of the incoming data into a selected one of data sinks wherein the selection is made based on the received data.

A further embodiment relates to an inter-processor communication method which includes generating—by a first processor core of a first subsystem—first data and storing the first data in a transmission queue of an event bus terminal of the first subsystem; generating—by the event bus terminal of the first subsystem—a data frame based on the first data and transmitting the data frame to an event bus controller, which includes an arbiter for arbitrating data transmission; receiving the data frame by an event bus terminal of a second subsystem and from the event bus controller; selecting—based on the received data frame—one of a plurality of data sinks and writing second data, which are based on the data frame, to the selected data sink; and retrieving and processing the second data by a second processor core of the second subsystem.

### BRIEF DESCRIPTION OF THE DRAWINGS

The invention can be better understood with reference to the following drawings and descriptions. The components in the figures are not necessarily to scale; instead emphasis is placed upon illustrating the principles of the invention. Moreover, in the figures, like reference numerals designate corresponding parts. In the drawings:

FIG. 1 illustrates a block diagram of one embodiment of an improved switching converter controller.

FIG. 2 illustrates an exemplary block diagram of an event bus and connected functional units and subsystems.

FIG. 3 includes timing diagrams illustrating the function of the event bus of FIG. 2.

FIG. 4 illustrates one exemplary embodiment of a subsystem which includes a (co-) processor core and an event bus terminal (EBT) for connecting to an event bus.

FIG. 5 illustrates an example of a data frame, which may be used to communicate over an event bus in accordance with the embodiments described herein.

FIG. 6 illustrates an exemplary implementation of an EBT in more detail.

FIGS. 7-9 illustrate examples of data frames transmitted via the event bus for communication classes, “job passing”, “message passing”, and “resource request”/“resource release”.

FIG. 10 illustrates an exemplary structure of a resource status register that may be used for managing shared resources.

FIG. 11 is a flow chart illustrating an example of inter-processor communication method which makes use of the event bus.

### DETAILED DESCRIPTION

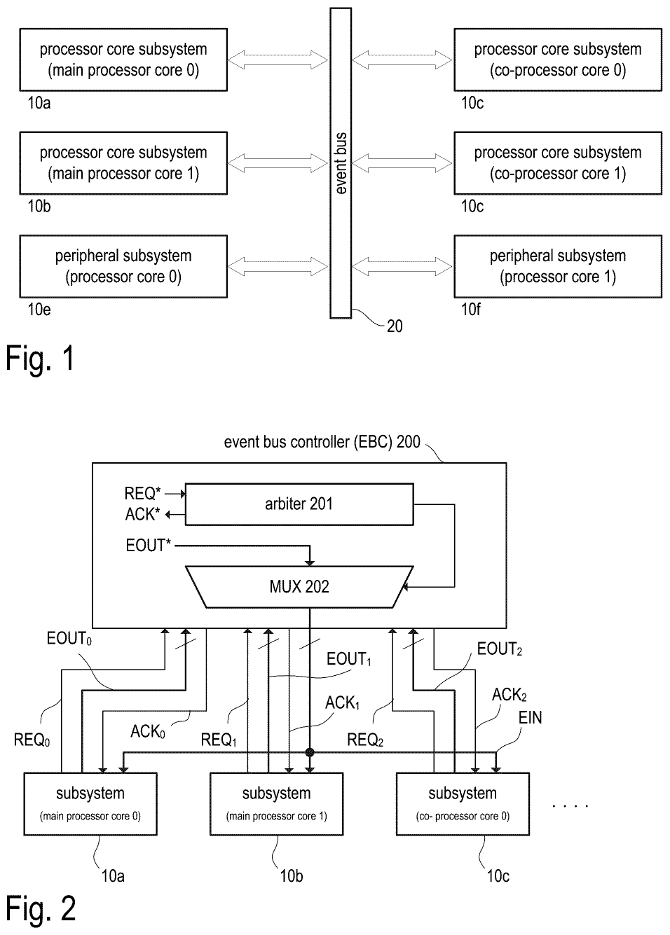

FIG. 1 illustrates, by means of example, the basic structure of a system with multiple processor cores and an event bus that is used for inter-processor communication. As mentioned, the event bus does supplement (not replace) the normal CPU bus, which may be used in a conventional manner to exchange data with, for example, random access memory and other functional units. To keep the illustration simple, only the event bus and the subsystems connected thereto are depicted in FIG. 1, wherein other bus systems have been omitted.

The system of FIG. 1 is composed of multiple subsystems 10a-f. These subsystems include, for example, cores 0 and 1 of the main processor (subsystems 10 and 10b), cores 0 and 1 of the co-processor (subsystems 10c and 10d) and peripheral circuits, which may also include processor cores (subsystems 10e and 10f). All these subsystems (and further subsystems and functional units) may exchange data via the event bus 20, which is configured to control the bus communication. The event bus 20 has the ability to establish point-to-point (P2P) communication and point-to-multipoint (P2MP) communication without involving one of the processors in the bus communication process.

FIG. 2 illustrates one exemplary implementation of an event bus 20. Accordingly, the event bus 20 includes an event bus controller (EBC) 200 and bus lines that connect the event bus controller 200 with each subsystem (bus node). In the present example, the subsystems 10a, 10b, 10c, etc. are connected to the event bus controller 200. The bus lines between the event bus controller 200 and the connected subsystems 10a, 10b, 10c, etc. include control lines REQ₀, REQ₁, REQ₂, etc. (request lines), ACK₀, ACK₁, ACK₂, etc. (acknowledge lines), as well as data lines EIN (input data lines) and EOUT₀, EOUT₁, EOUT₂, etc. (output data lines). In FIG. 2, the labels REQ*, ACK* and EOUT* are placeholders for the mentioned request lines, acknowledge lines and output data lines. In the present example, the request and acknowledge lines transmit binary (Boolean) control signals, whereas the input and output data lines transmit data signals, wherein the data signal may be composed of a plurality of bits (referred to as data word) transmitted in parallel.

The event bus controller 200 basically includes an arbiter 201 and a multiplexer 202. Generally, an arbiter is an electronic circuit which allocates access to shared resources which are, in the present example, the input data lines EIN. The label EIN denotes a set of parallel lines, as the data words to be transmitted are composed of a plurality of bits (e.g. 32 input data lines for the transmission of 32-bit data words). Similarly, each of the labels EOUT₀, EOUT₁, EOUT₂, etc. denote corresponding sets of output data lines. The request lines REQ₀, REQ₁, REQ₂ are connected to the arbiter 201, which may be an asynchronous arbiter configured to process requests from the connected subsystems 10a, 10b, 10c, etc. in a defined order which depends on the implemented arbitration algorithm. Various arbitration algorithms are as such known in the field and thus not discussed here. Generally, the arbiter guarantees that the state of the input data lines EIN represents the state of the output data lines of only one connected subsystem (e.g. lines EOUT₂ of subsystem 10c which includes the co-processor core 0) and thus prevents collision/interference of two subsystems trying to transmit data across the bus at the same time.

When receiving two or more concurrent requests, the arbiter 201 will determine an order, in which the requests will be processed. The first request of the determined order (e.g. from subsystem 10a) is then processed by configuring the multiplexer 202 to feed the output data generated by the requesting subsystem (subsystem 10a, in the present example) through to the input data lines EIN, so that all connected subsystems can read the output data generated by the requesting subsystem. Subsequently, the arbiter 201 may acknowledge the first request and process the second request in accordance with the determined order. Accordingly, the multiplexer 202 is reconfigured to feed the output data generated by the subsystem that generated the second request through to the input data lines EIN, and subsequently, the arbiter 201 may acknowledge the second request and process the next request (if any further request is pending).

As mentioned, numerous arbitrations algorithms exist for arbitrating concurrent requests. For example, a priority value may be assigned to the request lines REQ₀, REQ₁, REQ₂, etc. (and thus to the subsystems connected by the event bus). In this case, a request signaled via request line REQᵢ may have precedence over a request signaled via request line REQⱼ for i<j (assuming that lower indices have higher priority with 0 indicating the highest priority). In another example, a round robin method may be used to determine the order of the requests. Many other arbitration approaches may also be suitable.

It is noted that only those subsystems need to be connected to the input data lines EIN, which are to receive data via the event bus 20. Dependent on the implementation, some subsystems may be configured to only transmit data via the event bus (talk only); these subsystems need not be connected to the input data lines EIN. Similarly, only those subsystems need a connection to the event bus controller 230 via request lines REQ*, acknowledge lines ACK*, and output data lines EOUT*, which are to transmit data via the event bus 20. Dependent on the implementation, some subsystems may be configured to only receive data via the event bus (listen only); these subsystems do not need to be connected via request lines REQ*, acknowledge lines ACK*, and output data lines EOUT* (but only via the input data liens EIN). As mentioned, some subsystems may be configured to transmit and receive data using the event bus 20.

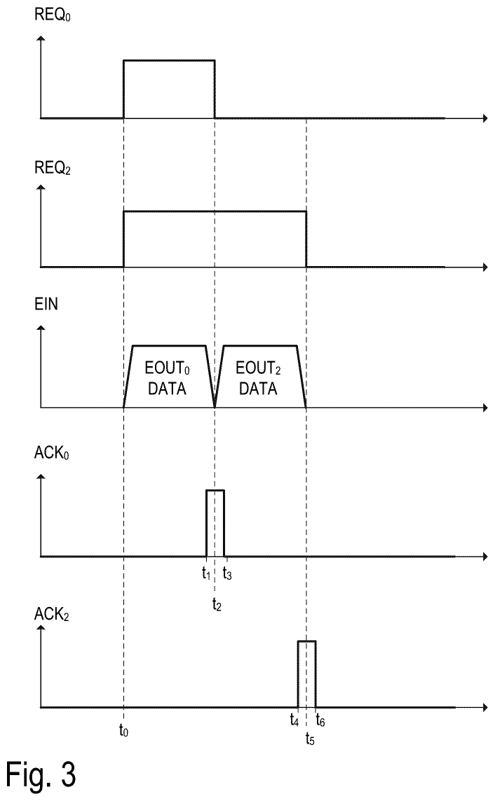

FIG. 3 includes timing diagrams of request and acknowledge signals to illustrate the function of an arbiter that uses fixed priorities assigned to the request lines REQ₀, REQ₁, REQ₂, etc. The first and the second timing diagrams of FIG. 3 illustrate request signals received by the arbiter 201 via the request lines REQ₀ and REQ₂. Referring to the example of FIG. 2, the subsystem 10a generates a request on request line REQ₀ indicating that subsystem 10a is ready to send a data word. At the same time, subsystem 10c generates a request on request line REQ₂. Both requests arrive at substantially the same time t₀, at which the logic level of the request signals changes from a Low Level (no request) to a High Level (active request).

The arbiter 201 gives precedence to the subsystem 10a that uses request line REQ₀ as 0 indicates a higher priority than 2. Accordingly, the arbiter 201 forwards the output data provided by subsystem 10a at the respective output data lines EOUT₀ to the input data lines EIN. The desired recipient of the data may be coded into the data word to be transmitted. For example, the first six bits (address field of data frame) of the input data word may be used to address 2⁶=64 different recipients. After a defined time span (i.e. at time t₁) the arbiter 201 acknowledges the request by setting the acknowledge line ACK₀ to a High Level. Upon receiving the acknowledge signal, the subsystem 10a withdraws, at time t₂, its request by resetting the logic level at the request line REQ₀ back to a Low Level (no request). The respective acknowledge signal is then reset to a Low Level a short time later, at time t₃.

After the subsystem 10a has withdrawn its request at request line REQ₀ at time instant t₂, the arbiter 201 can process the next request pending at request line REQ₂ and feed through the respective output data provided by subsystem 10c at the respective output data lines EOUT₂ to the input data lines EIN. Again, the desired recipient of the data may be coded into the data word to be transmitted. After a defined time span (i.e. at time t₄) the arbiter 201 acknowledges the request by setting the acknowledge line ACK₂ to a high level. Upon receiving the acknowledge signal, the subsystem 10c withdraws its request at time t₅ by resetting the logic level at the request line REQ₂ back to a Low Level (no request). The respective acknowledge signal is then reset to a Low Level a short time later at time t₆. The data is provided to the input data lines EIN as long as the request signal is active at the respective request line (line REQ₂ in the present example).

As can be seen from the example of FIGS. 1-3, an intra-IC bus such as the event bus 20 allows an efficient communication between different subsystems (which may include a processor core) of an SoC. No software for one of the processor cores is needed to manage the communication across the event bus. As such, the complexity of the software in the microcontroller is reduced and strict realtime requirements may more easily be complied with.

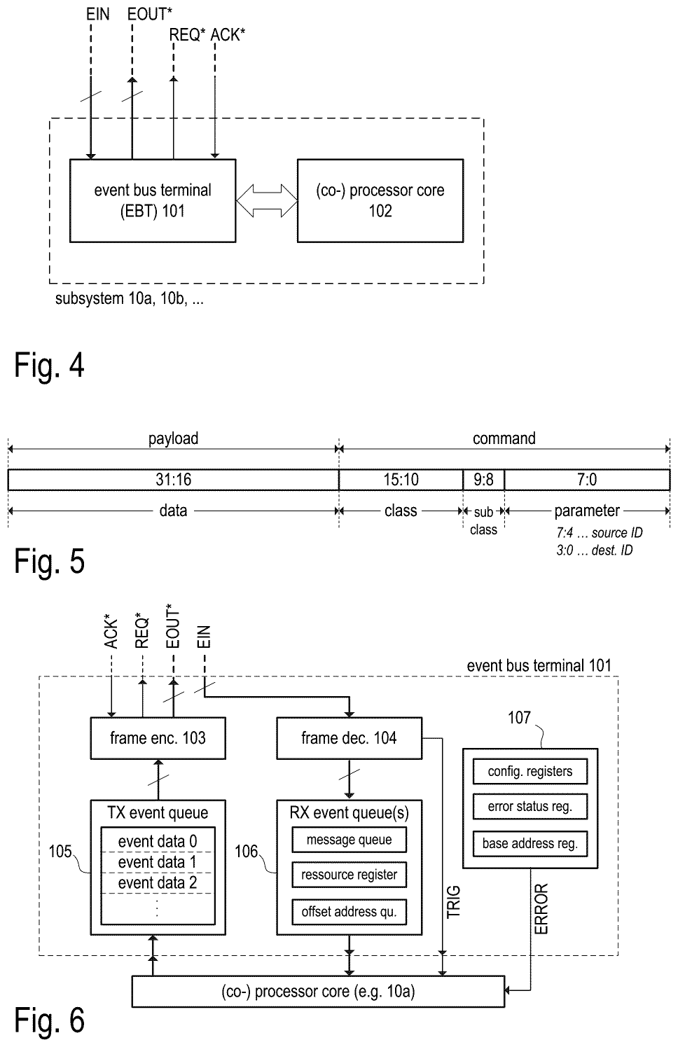

In order to better utilize the potential of the event bus, the subsystems 10a, 10b, 10c, etc. described herein include a so-called event bus terminal (EBT). FIG. 4 illustrates one exemplary embodiment of a subsystem which includes a (co-) processor core 102 and an EBT 101. The EBT 101 can be coupled to an event bus controller (see, e.g. FIG. 2) by the bus lines REQ*, ACK*, EOUT* and EIN. The EBT 101 can be regarded as an interface circuit between the event bus and the processor core 102.

FIG. 5 illustrates an example of a data frame, which may be used to communicate over an event bus (via the bus lines EOUT* and EIN) in accordance with the embodiments described herein. In the depicted embodiment, a 32-bit data frame is used, wherein the frame is subdivided in a command field (bits 0-15) and a payload field (bits 16-31). The command field is sometimes also referred to as “header”. It is understood that the terms “command field” and “payload field” are merely names used for distinguishing the two data fields of the frame. The command field may be composed of several sub-fields, in the present example the sub-fields “class”, “sub-class” and “parameter” are used. In the present example the parameter field (bits 0-7) may include a destination address/identifier (bits 0:3) and a source address/identifier (bits 4-7). These addresses or identifiers (IDs) identify the sender and the recipient of a data frame, whereas broadcast and multicast addresses are possible. In the present example with 4-bit IDs, seven destination IDs are possible wherein the eighth ID (e.g. 1111) serves as broadcast address. The class field and the sub-class field may include information concerning the type/category of the date included in the payload field. In another embodiment, each bit of the ID field is associated with a specific subsystem. Accordingly, if a bit is set, the respective subsystem is addressed.

It is understood that the size of a frame and the specific subdivision of the frame into fields may be different for different applications. The sizes and numbers used in the examples described herein have to be regarded as illustrative examples. For example, in some application the sub-class field may be omitted. In the present example, one specific class may be “inter processor communication” (IPC). If the data in the class field indicates IPC, then the sub-class indicates a specific kind of IPC such as, e.g., “job passing”, “shared resource request”, “shared resource release”, “message passing”, etc. Dependent on the class and sub-class identified in the header field of a frame, the recipient of a data frame will interpret the content of the payload field in a different way. Several examples will be discussed in more detail later.

FIG. 6 illustrates an exemplary implementation of an EBT in more detail. Accordingly, the EBT 101 includes a first queue 105 (TX event queue), in which those data frames are stored (queued) that are to be transmitted over the event bus, and one or more second queues 106 (RX event queue(s)), in which, e.g., the payload data of the received data frames are stored. Various different types of queues are as such known (such as first-in/first-out (FIFO) queues and thus not further discussed in more detail. The one or more second queues are merely an example for a generic data sink (or one or more data sink). Thus, data sink as discussed herein may be a queue. Accordingly, the one or more second queues 106 may generally be referred to as (one or more) data sinks for received data. In one example, a data sink is a type of computer program or device that collects and stores data from other devices or programs. It can be thought of as a destination point for data, where the data is stored and processed for later use.

Besides queues, the data sinks 106 may include one or more dedicated registers for storing the payload data of a received frame (or data derived from the payload data). One example for such a dedicated register is a status register for a shared resource or the like (e.g. an digital-to-analog converter, a digital output, a Universal Asynchronous Receiver-Transmitter (UART), a specific memory or portion of memory etc.). The data sinks 106 (a.k.a., queues) may comprise different queues or dedicated registers for different event classes, which are identified by the class field mentioned above (see FIG. 5). In the present example, the RX queues 106 comprise a message queue and an offset address queue. The data sinks may also include a resource (status) register. The message queue are used to store the payload fields of data frames, in which the class field indicates “message passing”, and the offset address queue is used to store the payload fields of data frames, in which the class field indicates “job passing”. If the class field of the data frame indicates “shared resource request” (or “shared resource release”) the resource register is updated based on the data included in the payload filed of the data frame. As mentioned, these different classes will be discussed later in more detail.

The TX event queue 105 is filled by the processor core (processor core 10a in the present example. That is, the processor core 10a stores data (e.g. payload data, event class, sub-class and destination ID) in the TX event queue 105, which may be a FIFO, and the frame encoder 103 (bus interface circuit) reads the data from the queue 105, composes the frame and outputs it at the EOUT* bus lines. The control lines REQ* and ACK* are also controlled/monitored by the frame encoder 103 to implement the request/acknowledge mechanism explained above with reference to FIG. 3.

The RX event queue(s) 106 is (are) filled by the frame decoder 104, which is configured to receive a data frame from the EIN bus lines, to decode the data frame, and to store the received data (e.g. the payload data) in the RX event queue(s) 106. If, like in the depicted example, more than one RX event queue is used, the frame decoder 104 may decide, e.g. based on the header field, whether incoming data is stored or not and (if yes) in which RX event queue the incoming data is stored. For example, the frame decoder 104 may be configured to compare the destination ID in the parameter field of an incoming data frame with the ID of the subsystem. This allows the frame decoder 104 to ignore/discard an incoming data frame if the destination ID of the frame does not match with the ID of the subsystem receiving the frame.

Furthermore, the frame decoder 104 may be configured to analyze data in the class and sub-class fields of an incoming frame to find out whether the class and sub-class data matches with one of the classes and sub-classes the subsystem is able to process. If this is the case, the frame decoder 104 may decide, based on the class and sub-class data of an incoming frame, in which RX event queue 106 the payload data of the respective frame is stored. For example, if the class data (included in an incoming frame) indicates “IPC” and the sub-class data indicates “job passing”, then the payload data of the incoming frame may be stored in the offset address queue of the RX event queues 106 (provided that the destination ID included in the header field of the incoming frame matches with the ID of the receiving subsystem). The frame decoder 104 may also be configured to signal, to the processor core, that new data (an “event”) is received and stored in the RX even queues 106. As shown in FIG. 6, the control line TRIG may signal a new event.

As shown in FIG. 6, the EBT 101 may include further circuitry and registers such as the set of registers 107, which may include, configuration registers, an error status register, a base address register, etc. It is noted that these registers 107 need not be necessarily present in all embodiments. It heavily depends on the actual application whether one of more of these registers are used. In one embodiment, the ERROR signal indicates, to the processor core, the content of the error status register. The error status may, for example, indicate that an event with invalid/unknown class or sub-class data has been received.

The event bus terminal 101 may include further registers 107. These may include a base address register and a configuration register, which may be readable and writable by an external controller (e.g. system controller) and store configuration information for the event bus terminal. The content and the purpose of the configuration register(s) are not important for the embodiments described herein and may heavily depend on the actual application and system specification. For example, the configuration register may contain EBT specific configuration information (e.g. the EBT terminal ID).

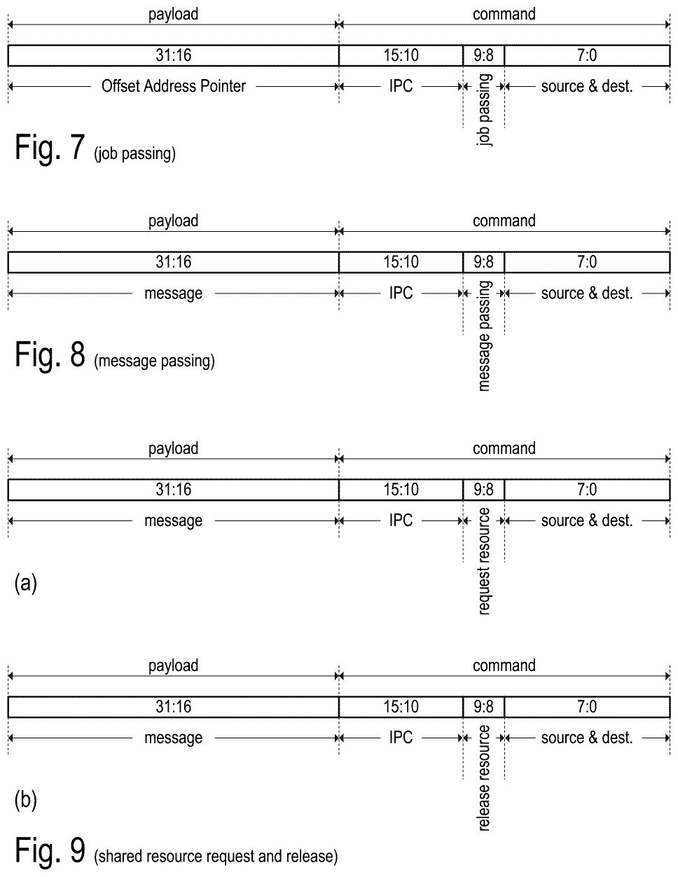

The base address register may store a (e.g. 32 bit) base address of a memory section, where program code/software routines, which may be executed by the respective processor, are located. Based on the content of offset address queue, the function pointer of the program code (job) may be calculated by adding the offset address to the base address (see also FIG. 7 related to job passing). The error status register may be used to store an error (e.g. when an invalid message is received).

An EBT may be used in each bus node, i.e. in each subsystem connected to the event bus. The TX event queues and RX event queues allow a processor core to efficiently use the advantages provided by the event bus. In the following, some applications are discussed in more detail by way of example.

FIG. 7 illustrates the content of a data frame which is used to pass one job from one processor core to another processor core. In this context a “job” denotes a task (i.e. a software routine) to be executed by the processor core of a specific subsystem that is identified by the destination ID included in the data frame (see FIG. 5). As an illustrative example, a scenario is considered, in which the main processor core 0 of subsystem 10a passes a job (e.g. the calculation of a Fourier Transform) to the co-processor core 0 of subsystem 10c (see FIG. 2). Here the bits [31:16] represent an offset address, which is passed to the (co-) processor of the subsystem addressed by the destination ID (destination processor). In the destination EBT, there is a base address register as shown in FIG. 6 (see registers 107). The job to be executed by destination processor is located at address which can be obtained by adding the offset address received via the event bus to the base address register included in the base address register of the respective subsystem.

In this scenario, the main processor core 0 subsystem 10a will generate a data frame and store it in the TX event queue of the EBT of subsystem 10a. In accordance with FIG. 7, the class field in the header of data frame will indicate IPC as event class (e.g. bits 10-15 may be “000010” indicating the class “IPC”). The sub-class field in the header of data frame will indicate “job passing” as sub-class of the event (e.g. bits 8-9 may be “01” indicating the sub-class “job passing”). The parameter field includes the source and destination ID. For example, “00010100” denotes the source ID “0001” of subsystem 10a and the destination ID “0100” of the subsystem 10c. In the present example, the payload data is the offset address pointer which identifies (i.e. points to) the address of the job (software task) to be executed by co-processor core 0 of subsystem 10c. In another embodiment, absolute addresses may be included in the payload data field (instead of relative addresses which represent the offset relative to the base address).

The subsystem 10c will receive the data frame shown in FIG. 7, and the frame decoder 104 of the EBT of the subsystem 10c will decode the received data frame. Based on the header of the data frame the frame decoder 104 checks whether the destination ID is the ID of subsystem 10c. If this is the case, the frame decoder 104 can determine—based on the header—that the event class is IPC and the sub-class is “job passing”. As a consequence, the frame decoder 104 will store the payload data (i.e. the offset address pointer) in the offset address queue of the RX event queues 106 and signal the event to the co-processor core 0 of subsystem 10c. The co-processor core 0 can then read the offset address pointer from the respective queue, read the software instructions identified by the offset address pointer from the (e.g. shared) memory, and start executing these software instructions. As mentioned, the actual address may be obtained by adding the offset address received from the event bus and the base address stored in the base address register of the subsystem (see FIG. 6, registers 107).

FIG. 8 illustrates the content of a data frame which is used to send a message from one processor core to another processor core. In this context a “message” may denote any kind of data, which may be a calculated measurement result, a subsystem status, an encoded application-specific action trigger (e.g. to start a measurement), or the like. As an illustrative example, a scenario is considered, in which the main processor core 0 of subsystem 10a sends a message (e.g. the result of a specific calculation that the other subsystem needs to know) to the co-processor core 0 of subsystem 10c (see FIG. 2).

In this scenario, the main processor core 0 subsystem 10a will generate a data frame and store it in the TX event queue of the EBT of subsystem 10a. The payload data of this frame represents the mentioned message. In the present example, the class field and the parameter field of the header are the same as in the previous example of FIG. 7, whereas the sub-class field in the header of data frame indicates “message passing” as sub-class of the event (e.g. bits 8-9 may be “00” indicating the sub-class “message passing”).

The subsystem 10c will receive the data frame shown in FIG. 7, and the frame decoder 104 of the EBT of the subsystem 10c will decode the received data frame. Based on the header of the data frame the frame decoder 104 detects that the destination ID is the ID of subsystem 10c. Then the frame decoder 104 can determine—based on the header—that the event class is IPC and the sub-class is “message passing”. As a consequence, the frame decoder 104 will store the payload data (i.e. the message) in the message queue of the RX event queues 106 and signal the event to the co-processor core 0 of subsystem 10c. The co-processor core 0 can then read the message from the respective queue, and process the data included in the message.

FIG. 9 (diagrams (a) and (b)) illustrates the content of data frames which are used to request and release a shared resource by a processor core. In this context a “shared resource” may denote for example a digital-to analog converter, or any other shared data source or data sink. As an illustrative example, a scenario is considered, in which the main processor core 0 of subsystem 10a broadcasts an event to inform the other subsystems that a specific shared resource is requested.

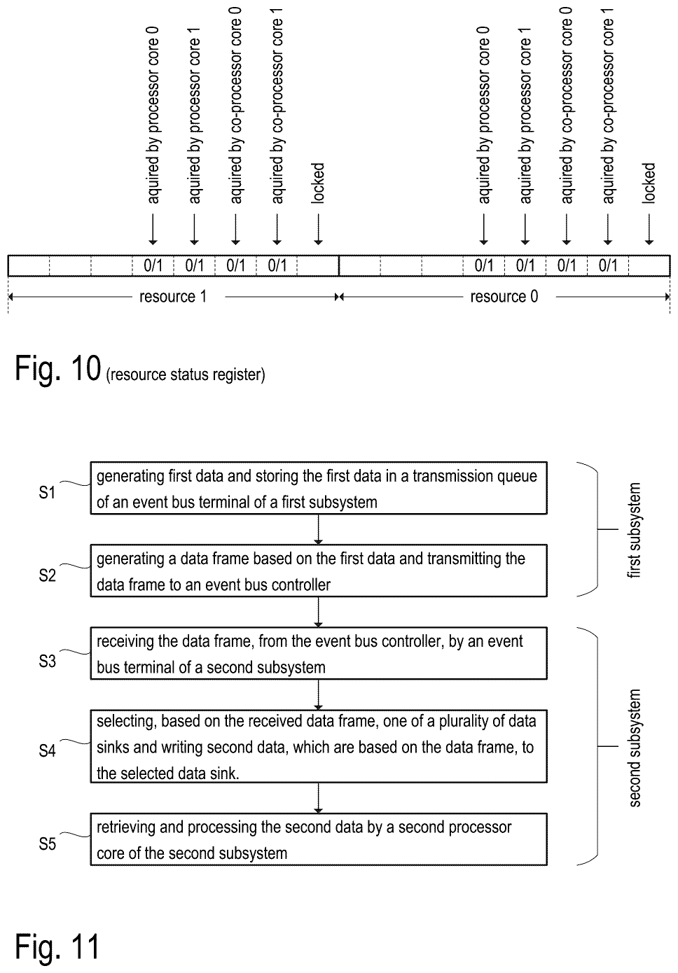

FIG. 10 illustrates an exemplary structure of a resource register (resource status register) that may be used for managing shared resources. In the examples described herein, the resource register may be regarded as a set of binary semaphores which is used to control access to specific shared resources. Accordingly, the register is subdivided into several fields (bit groups) associated to a particular shared resource, which are referred to as “resource 0” and “resource 1” in the depicted example. The field for each resource includes a dedicated bit position associated with a particular (co-) processor core. For example, if “processor core 0” (subsystem 10a in the previous examples) requests control over “resource 1”, the respective bit position of in the field associated with resource 0 may be set to “1” when a “resource request event” is received. When the resource is released, the respective bit position may be reset to “0” when a “resource release event” is received. In the depicted embodiment, the resource register includes a lock bit for each resource that indicates whether the respective resource is locked or not. A locked resource cannot be accessed by a subsystem (except the subsystem which has currently acquired the resource). These events are, for example, broadcasted to all subsystems, so that the event bus terminals in all subsystems have an up-to-date resource status register. According to the concept described herein, all resource status registers of different subsystems can be updated within the same clock cycle. The concept of binary semaphores to implement locks (or mutex) or the like is as such known and thus not further discussed herein.

An example of an inter-processor communication using “events” transmitted via the event bus is summarized below. In the example discussed below, processor core 0 (first processor core) of a first subsystem communicates with a processor core 1 (second processor core) of a second subsystem (see, e.g. FIG. 2, subsystems 10a and 10b). Accordingly, the first processor core generates first data and stores it in a transmission queue of the event bus terminal of the first subsystem (see, e.g. FIG. 6, event bus terminal 101, TX event queue 105). The event bus terminal of the first subsystem generates a data frame based on the first data and transmits the data frame to an event bus controller (see FIG. 2, event bus controller 200) thereby issuing an “event”. As discussed in detail above, the event bus controller includes an arbiter for arbitrating data transmission across the bus lines which connect each subsystem to the event bus controller.

The event bus terminal of the second subsystem receives the data frame from the event bus controller, selects—based on the received data frame—one of a plurality of data sinks, and writes second data, which are based on the data frame, to the selected data sink. The second processor of the second subsystem may then retrieve and process the second data. In one particular embodiment, the event bus terminal of the second subsystem signals, to the second processor, the detection of a new event (the reception of a new data frame). As mentioned the data sinks may include one or more reception queues (message queue, address queue, etc.) and one or more registers (e.g. resource status register or the like).

In order to request control over a specific shared resource, the first processor of the first subsystem may issue a specific event. In this case, first data (generated by the first processor), and thus also the transmitted data frame, includes payload data indicating the specific shared resource as well as information concerning the class of the communication (event class). The event class is “resource request” in the present example. On the recipients side (i.e. in the event bus terminal of the second subsystem) the selection of one of the plurality of data sinks is done based on the event class indicated by the received data frame. In the present example, the selected data sink is the resource status register (see FIGS. 6 and 10). The above-mentioned “second data” represents the shared resource. Assuming the first processor core requests control over “resource 1” (see FIG. 10), writing the second data to the resource status register results in the bit position 12 (bit position 0 is right) being set to 1.

The above described process allows the first processor to inform all other processors of the subsystem (if a broadcast address is used as destination ID) about the shared resource request and to update the resource status registers in each subsystem. Releasing the shared resource works basically the same way. The only difference is that the event class is “resource release” with the result that the respective bit position in the share resource register is reset in each subsystem.

In some embodiments, the event class may be determine by the combination of (main) class and sub-class. For example, the main class may be “inter-processor communication” and the “sub-class” may be “resource request”. This allows to use the event bus more flexibly also for other types of communication and not only inter-processor communication. It is, nevertheless understood, that main class and sub-class together may be considered as indication of a specific event class. Moreover, the particular structure of the resource register may heavily depend on the actual implementation.

The process described above may also be used to pass a job/task (i.e. a software routine consisting of a sequence of software instructions) from one processor core to another processor core, i.e. from the first processor core in the first subsystem to the second processor core in the second subsystem to elaborate on the previous example.

In order to pass a task to the second processor core, the first processor of the first subsystem may issue a specific event. In this case, the first data (generated by the first processor), and thus also the transmitted data frame, includes payload data indicating an (offset) address pointer as well as information concerning the class of the communication (event class). The event class now is “job passing”. On the recipients side (i.e. in the event bus terminal of the second subsystem) the selection of one of the plurality of data sinks is done based on the event class indicated by the received data frame. Accordingly, the selected data sink is the offset address queue (see FIGS. 6 and 10) as the event class indicates “job passing”. The above-mentioned “second data” represents the offset address pointer which is (or is extracted from) the payload data of the received data frame. The second processor core of the second subsystem is now able to process the address pointer stored in the queue, retrieve software instructions from the memory location identified by the address pointer and execute these software instructions (i.e. the job/task).

Also messages may be transmitted from one processor core to another using the concept described herein. In order to transmit a message to the second processor core, the first processor of the first subsystem may issue a specific event. In this case, the first data (generated by the first processor), and thus also the transmitted data frame, includes payload data representing the message to be sent as well as information concerning the class of the communication (event class). The event class now is “message passing”. On the recipients side (i.e. in the event bus terminal of the second subsystem) the selection of one of the plurality of data sinks is done based on the event class indicated by the received data frame. Accordingly, the selected data sink is the message queue (see FIGS. 6 and 10) as the event class indicates “message passing”. The above-mentioned “second data” also represents the message, which is (or is extracted from) the payload data of the received data frame. The second processor core of the second subsystem is now able to retrieve the message from the message queue, process and, as the case may be, react on it.

FIG. 11 is a flow chart illustrating one example of the inter-processor communication method described above. Accordingly, the method includes generating—by a first processor core of a first subsystem—first data and storing the first data in a transmission queue of an event bus terminal of the first subsystem (see FIG. 11, box S1). The method further includes generating—by the event bus terminal of the first subsystem-a data frame based on the first data and transmitting the data frame to an event bus controller (see FIG. 11, box S2), which includes an arbiter for arbitrating data transmission (see also FIG. 2). Furthermore, the method includes receiving the data frame by an event bus terminal of a second subsystem and from the event bus controller (see FIG. 11, box S3); selecting—based on the received data frame—one of a plurality of data sinks and writing second data, which are based on the data frame, to the selected data sink (see FIG. 11, box S4); and retrieving and processing the second data by a second processor core of the second subsystem (see FIG. 11, box S5).

The plurality of data sinks may include one or more second queues and/or one or more registers (see FIG. 6, queues/registers 106). The first data and the transmitted data frame may include payload data and information concerning the class of the communication, wherein the selection of one of a plurality of data sinks may be done based on the class of the communication (see FIG. 7-9). For example, the payload data may be a message for the second processor core of the second subsystem when the communication class is “message passing”. In this case, the second data may be the message included in the received data frame and the selected data sink is a message queue (see FIG. 6, queues/registers 106).

In one example, the payload data may include an address pointer that points to a memory location when the communication class is “job passing”. In this case the second data may be the address pointer (e.g. an offset address pointer) included in the received data frame and the selected data sink is an address queue (see FIG. 6, queues/registers 106). The processing of the second data may include retrieving software instructions from the memory location identified by the address pointer and executing the software instructions.

In another example, the payload data may include information identifying a shared resource when the communication class is “resource request” or “resource release”. In this case, the second data may represent the shared resource, wherein the selected data sink is an resource status register. (see FIG. 6, queues/registers 106).

Although the invention has been illustrated and described with respect to one or more implementations, alterations and/or modifications may be made to the illustrated examples without departing from the spirit and scope of the appended claims. In particular regard to the various functions performed by the above described components or structures (units, assemblies, devices, circuits, systems, etc.), the terms (including a reference to a “means”) used to describe such components are intended to correspond—unless otherwise indicated—to any component or structure, which performs the specified function of the described component (e.g., that is functionally equivalent), even though not structurally equivalent to the disclosed structure, which performs the function in the herein illustrated exemplary implementations of the invention.

1. A system comprising:
a first subsystem and a second subsystem, each including an event bus terminal and a processor core;
an event bus comprising an event bus controller and a plurality of bus lines for connecting the first subsystem and the second subsystem with the event bus controller, wherein the event bus controller includes an arbiter configured to arbitrate data transmission across the bus lines;
wherein the event bus terminal of each subsystem includes a first queue for outgoing data provided by the respective processor core and a frame encoder that is configured to read the outgoing data from the first queue and transmit the outgoing data to the event bus controller; and
wherein the event bus terminal of each subsystem further includes a frame decoder that is configured to receive incoming data from the event bus controller and to write at least a portion of the incoming data into a selected first data sink of multiple data sinks, wherein the first data sink is selected based on the received incoming data.

2. The system of claim 1,
wherein the frame decoder of each subsystem is further configured to extract a destination ID from the incoming data and to discard the incoming data during a detected condition in which the destination ID is not associated with the respective subsystem.

3. The system of claim 1,
wherein the frame decoder of each subsystem is further configured to extract a communication class from the incoming data, wherein the selection of the first data sink is made based on the communication class.

4. The system of claim 1,
wherein the frame decoder of each subsystem is further configured to extract payload data from the incoming data, wherein the payload data is stored in the selected first data sink.

5. The system of claim 4,
wherein the frame decoder of each subsystem is further configured to signal, to the processor core of the respective subsystem, a condition in which new data has been written into the first data sink.

6. A inter-processor communication method comprising:
generating, by a first processor core of a first subsystem, first data and storing the first data in a transmission queue of an event bus terminal of the first subsystem,
generating, by the event bus terminal of the first subsystem, a data frame based on the first data and transmitting the data frame to an event bus controller, which includes an arbiter for arbitrating data transmission;
receiving, by an event bus terminal of a second subsystem and from the event bus controller, the data frame;
selecting, based on the received data frame, a first data sink of multiple data sinks and writing second data, which are based on the data frame, to the first data sink.
retrieving and processing the second data by a second processor core of the second subsystem.

7. The method of claim 6,
wherein the multiple data sinks include second queues and registers.

8. The method of claim 7,
wherein the first data and the transmitted data frame include payload data and information concerning a class of associated with a communication, and
wherein selecting the first data sink of the multiple data sinks is done based on the class of the communication.

9. The method of claim 8,
wherein the payload data is a message for the second processor core of the second subsystem and the communication class is message passing, and
wherein the second data is the message included in the received data frame and the selected data sink is a message queue.

10. The method of claim 8,
wherein the payload data includes an address pointer that points to a memory location and the communication class is job passing,
wherein the second data is the address pointer included in the received data frame and the selected data sink is an address queue, and
wherein processing the second data includes, retrieving software instructions from the memory location identified by the address pointer and executing the software instructions.

11. The method of claim 8,
wherein the payload data includes information identifying a shared resource and the communication class is resource request or resource release,
wherein the second data represents the shared resource and wherein the selected first data sink is a resource status register.
